(19) United States
(12) Patent Application Publication
(10) Pub. No.: US 2016/0057291 A1
(43) Pub. Date: Feb. 25, 2016

(54) ENABLING MONITORING AND REPORTING FOR DYNAMIC POLICY ENFORCEMENT IN MULTI-OPERATOR WHOLESALE NETWORKS

(71) Applicant: NOKIA SOLUTIONS AND NETWORKS OY, Espoo (FI)

(72) Inventors: Krishnan IYER, Dunwoody, GA (US); Raymond JONG-A-KIEM, Garland, TX (US); Mihai Alexandru BURLACU, Roswell, GA (US)

(21) Appl. No.: 14/778,770

(22) PCT Filed: Mar. 22, 2013
(86) PCT No.: PCT/US13/33545

§ 371 Date: Sep. 21, 2015

(51) Int. Cl. H04M 15/00

(52) U.S. Cl. CPC H04M 15/66; H04M 15/41

(57) ABSTRACT

Monitoring and reporting for policy enforcement may benefit various communication systems. For example, multi-operator wholesale networks may benefit from enablement of monitoring and reporting for dynamic policy enforcement. A method may include receiving a credit control request at a policy control function, wherein the request comprises an international mobile subscriber identity. The method may also include querying, by the policy control function, a home subscriber server with a query, wherein the query comprises the international mobile subscriber identity. The method may further include obtaining a tenant identifier corresponding to the international mobile subscriber identity from the home subscriber server in response to the query. The method may additionally include responding with a response to the credit control request based on the tenant identifier.

### BACKGROUND

1. Field

Monitoring and reporting for policy enforcement may benefit various communication systems. For example, multi-operator wholesale networks may benefit from enablement of monitoring and reporting for dynamic policy enforcement.

2. Description of the Related Art

Multi-operator wholesale network is a set of business strategies that, in the mobile broadband wireless world, aim to provide an appropriate answer to spectrum costs, spectrum shortage and capital expenditure to upgrade networks. The multi-operator wholesale network model includes both network sharing and network hosting. Network sharing can relate to multiple operators collaborating to share network resources like spectrum, equipment, and the like. Network hosting can relate to a case where an independent entity owns spectrum and builds the network end to end. The independent entity then hosts multiple operators as tenants in the network and can realize revenue from these tenants.

Although multi-operator access network models can address issues with respect spectrum shortage, these models can create a complex network resource sharing model, where usage of shared resources may need to be monitored and regulated.

Majority of evolved packet system (EPS) are owned and operated by a single operator based. There are scenarios where operators enter into roaming agreements or share radio or core resources using a multi-operator core network (MOCN) and/or multi-operator radio access network (MORAN) architectures. In such architectures, 3GPP allows operator differentiation using public land mobile network (PLMN) identifier (ID), an identifier which uniquely identifies the subscriber and international mobile subscriber identity (IMSI) for resource usage monitoring and billing purposes. In case of wholesale networks, where multiple tenants are hosted by single operator and where various network element resources are shared between tenants, tenant differentiation is not possible using PLMN ID and there is no known conventional technique to monitor usage of resources by individual tenant subscribers, to apply tenant specific billing, charging and to implement tenant specific policies.

### SUMMARY

According to a first embodiment, a method includes receiving a credit control request at a policy control function, wherein the request comprises an international mobile subscriber identity. The method also includes querying, by the policy control function, a home subscriber server with a query, wherein the query comprises the international mobile subscriber identity to identify the subscriber. The method further includes obtaining a tenant identifier associated with the international mobile subscriber identity from the home subscriber server in response to the query. The method additionally includes responding with a response to the credit control request based on the tenant identifier.

According to a second embodiment, a method includes sending a credit control request to a policy control function, wherein the request comprises an international mobile subscriber identity. The method also includes receiving a credit control response from the policy control function, wherein the response comprises a tenant identifier associated with the international mobile subscriber identity.

According to a third embodiment, a method includes receiving a user data request from a policy control function, wherein the request comprises an international mobile subscriber identity. The method also includes retrieving a tenant identifier associated with the international mobile subscriber identity in response to the request. The method further includes providing the tenant identifier in a user data acknowledgment to the policy control function.

According to a fourth embodiment, a method includes receiving a tenant report from a policy enforcement function or a policy control function. The method also includes aggregating data in the tenant report with data from other tenant reports. The method further includes storing the data in a database instance.

According to a fifth embodiment, an apparatus includes at least one processor and at least one memory including computer program code. The at least one memory and the computer program code are configured to, with the at least one processor, cause the apparatus at least to receive a credit control request at a policy control function, wherein the request comprises an international mobile subscriber identity. The at least one memory and the computer program code are also configured to, with the at least one processor, cause the apparatus at least to query, by the policy control function, a home subscriber server with a query, wherein the query comprises the international mobile subscriber identity. The at least one memory and the computer program code are further configured to, with the at least one processor, cause the apparatus at least to obtain a tenant identifier associated with the international mobile subscriber identity from the home subscriber server in response to the query. The at least one memory and the computer program code are additionally configured to, with the at least one processor, cause the apparatus at least to respond with a response to the credit control request based on the tenant identifier.

According to a sixth embodiment, an apparatus includes at least one processor and at least one memory including computer program code. The at least one memory and the computer program code are configured to, with the at least one processor, cause the apparatus at least to send a credit control request to a policy control function, wherein the request comprises an international mobile subscriber identity. The at least one memory and the computer program code are also configured to, with the at least one processor, cause the apparatus at least to receive a credit control response from the policy control function, wherein the response comprises a tenant identifier corresponding to the international mobile subscriber identity.

According to a seventh embodiment, an apparatus includes at least one processor and at least one memory including computer program code. The at least one memory and the computer program code are configured to, with the at least one processor, cause the apparatus at least to receive a user data request from a policy control function, wherein the request comprises an international mobile subscriber identity. The at least one memory and the computer program code are also configured to, with the at least one processor, cause the apparatus at least to retrieve a tenant identifier associated with the international mobile subscriber identity in response to the request. The at least one memory and the computer program code are further configured to, with the at least one processor, cause the apparatus at least to provide the tenant identifier in a user data acknowledgment to the policy control function.

According to an eighth embodiment, an apparatus includes at least one processor and at least one memory including computer program code. The at least one memory and the computer program code are configured to, with the at least one processor, cause the apparatus at least to receive a tenant report from a policy enforcement function or a policy control function. The at least one memory and the computer program code are also configured to, with the at least one processor, cause the apparatus at least to aggregate data in the tenant report with data from other tenant reports. The at least one memory and the computer program code are further configured to, with the at least one processor, cause the apparatus at least to store the data in a database instance.

According to a ninth embodiment, an apparatus includes receiving means for receiving a credit control request at a policy control function, wherein the request comprises an international mobile subscriber identity. The apparatus also includes means for querying, by the policy control function, a home subscriber server with a query, wherein the query comprises the international mobile subscriber identity. The apparatus further includes obtaining means for obtaining a tenant identifier corresponding to the international mobile subscriber identity from the home subscriber server in response to the query. The apparatus additionally includes responding means for responding with a response to the credit control request based on the tenant identifier.

According to a tenth embodiment, an apparatus includes sending means for sending a credit control request to a policy control function, wherein the request comprises an international mobile subscriber identity. The apparatus also includes receiving means for receiving a credit control response from the policy control function, wherein the response comprises a tenant identifier corresponding to the international mobile subscriber identity.

According to an eleventh embodiment, an apparatus includes receiving means for receiving a user data request from a policy control function, wherein the request comprises an international mobile subscriber identity. The apparatus also includes retrieving means for retrieving a tenant identifier associated with the international mobile subscriber identity in response to the request. The apparatus further includes providing means for providing the tenant identifier in a user data acknowledgment to the policy control function.

According to a twelfth embodiment, an apparatus includes receiving means for receiving a tenant report from a policy enforcement function or a policy control function. The apparatus also includes aggregating means for aggregating data in the tenant report with data from other tenant reports. The apparatus further includes storing means for storing the data in a database instance.

According to thirteenth through sixteenth embodiments respectively, a non-transitory computer-readable medium is encoded with instructions that, when executed in hardware, perform a process, the process corresponding respectively to the methods of the first through fourth embodiments.

According to a seventeenth embodiment, a system includes a first apparatus comprising receiving means for receiving a credit control request at a policy control function, wherein the request comprises an international mobile subscriber identity, querying means for querying, by the policy control function, a home subscriber server with a query, wherein the query comprises the international mobile subscriber identity, obtaining means for obtaining a tenant identifier corresponding to the international mobile subscriber identity from the home subscriber server in response to the query, and responding means for responding with a response to the credit control request based on the tenant identifier. The system also includes a second apparatus comprising sending means for sending the credit control request to the policy control function and receiving means for receiving the credit control response from the policy control function, wherein the response comprises a tenant identifier corresponding to the international mobile subscriber identity. The system further includes a third apparatus comprising receiving means for receiving a user data request from the policy control function, wherein the request comprises an international mobile subscriber identity, retrieving means for retrieving a tenant identifier associated with the international mobile subscriber identity in response to the request, and providing means for providing the tenant identifier in a user data acknowledgment to the policy control function. The system additionally includes a fourth apparatus comprising receiving means for receiving a tenant report from a policy enforcement function or the policy control function, aggregating means for aggregating data in the tenant report with data from other tenant reports, and storing means for storing the data in a database instance.

### BRIEF DESCRIPTION OF THE DRAWINGS

For proper understanding of the invention, reference should be made to the accompanying drawings, wherein:

FIG. 1 illustrates tenant identifier attribute definition in a subscriber database according to certain embodiments.

FIG. 2 illustrates an example call flow illustrating use cases according to certain embodiments.

FIG. 3 illustrates an interaction of a logical depository with policy decision engines and policy enforcement engines according to certain embodiments.

FIG. 4 illustrates how a logical depository can compile, aggregate and store data according to certain embodiments.

FIG. 5 illustrates a method according to certain embodiments.

FIG. 6 illustrates a system according to certain embodiments.

### DETAILED DESCRIPTION

Certain embodiments provide a unique way to monitor and report usage of shared network resources in multi-operator wholesale networks, both for network sharing scenarios and for hosting scenarios. This may be possible while enabling the tenants to maximize their own respective revenue potentials.

In multi-operator wholesale network models, it may be valuable to monitor usage of scarce network resources to enable efficient sharing across all tenants. The shared and hosted operation in today's evolved packet system (EPS) wireless network may impose complexity of usage reports that involve multi-dimensional reporting capabilities. Certain embodiments provide a unique method to enable reporting and aggregating metrics across multiple tenants. These reports can then be used to dynamically enforce policies to ensure efficient utilization of shared network resources. Examples of key challenges experienced by today's operators using wholesale network model are described below.

Third generation partnership project (3GPP) allows use of PLMN ID's and IMSI to report and account for charging of hosted subscribers. In a wholesale network model, a single operator may host multiple tenants as virtual operators. All hosted tenants can share the same PLMN ID as the operator hosting them. Hence differentiation based on PLMN may not always be possible. The use of a new PLMN ID for additional virtual operators could become an administrative burden, as the number of tenants increases.

IMSI of subscribers from hosted tenants may have same mobile country code (MCC) and mobile network code (MNC). Thus, differentiation of tenants based on IMSI may be an operational challenge

Operators in wholesale networks may be challenged with billing and efficiently monitoring and regulating resources used by their hosted tenants. Moreover, as demand for data usage surges among hosted tenants, wholesale operators may need to implement intelligent tenant specific pricing models.

All these above-mentioned challenges may lead to the use of a unique ID, such as a “Tenant ID,” that a wholesale operator can use to monitor usage of resources by individual tenant subscribers, as well as to apply tenant specific billing and charging and to implement tenant specific policies.

As mentioned above, in multi-operator wholesale network models, it may be valuable to monitor usage of precious network resources to enable efficient sharing across all tenants. Certain embodiments provide a unique method to enable reporting and aggregating metrics across multiple tenants. Likewise, certain embodiments provide tenant differentiation using a unique “Tenant Identifier” attribute value pair (AVP).

Moreover, certain embodiments provide a logical depository that allows dynamic aggregation per tenant. The logical repository can be configured to aggregate various metrics such as throughput, data volume, and the like. Moreover, the logical depository of certain embodiments can seamlessly integrate with policy and charging enforcement function (PCEF), bearer binding and event reporting function (BBERF) or can physically reside within the same physical entity. Furthermore, the logical depository of certain embodiments can communicate with policy decision engines such as policy and charging rules function (PCRF) and the like using diameter or Radius protocol.

Certain embodiments can use the “Tenant Report” AVP to configure tenant level reporting. Furthermore, certain embodiments use “Reporting Interval” and “Reporting Threshold” AVPs within a tenant report to help customize tenant reporting. Moreover, certain embodiments, using a tenant ID AVP, can create physical separation of tenant data across all network elements, as well as at the transport layer

Moreover, certain embodiments address the following challenges observed in multi-operator wholesale network models. For example, certain embodiments address enabling reporting of key metrics to monitor usage of shared resources among tenants using a unique identifier called the “Tenant ID.” The unique identifier may also be assigned alternative names, but is called “Tenant ID” here for clarity and by way of illustration. Likewise, certain embodiments permit data aggregation across multiple network segments and network elements for each tenant to enable micro resource management, billing using “Tenant ID,” tenant reporting, and the like. Furthermore, certain embodiments permit data aggregation across multiple tenants to enable macro resource management, billing, and the like across multiple tenants using a logical depository.

Certain embodiments provide implementation of a logical depository that can seamlessly integrate with existing network elements in all 3GPP networks. For example, the logical depository may be able to enable tenant differentiation using a unique tenant identifier, such as “Tenant-ID.” Moreover, the logical depository may be able to integrate directly to policy enforcing elements like a PCEF, including packet data network gateway (PDN-GW), high rate packet data (HRPD) serving gateway (HSGW), and the like. Alternatively, the logical depository can physically reside in the same network entity.

The logical depository may communicate with the policy enforcing entities and policy decision points using RADIUS or Diameter protocol. Moreover, the logical depository may receive Tenant-ID information for subscribers from a home subscriber server (HSS) via policy enforcing entities or policy decision points.

Moreover, the logical depository may act as a data aggregation point to monitor network usage per tenant. Furthermore, the logical depository may allow hosts to configure various aggregation methods for monitoring network usage among tenant using metrics like Data volume, throughput, or the like.

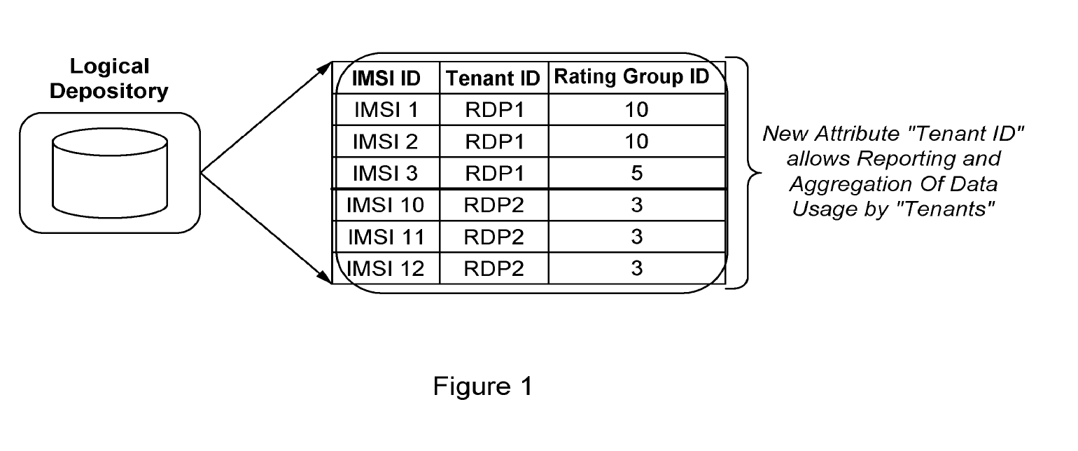

The implementation of certain embodiments is illustrated through example call flows. A new attribute for identifying tenants called “Tenant-ID” can be defined as a part of a subscriber profile in all subscriber profile repositories. FIG. 1 illustrates database instance of a logical profile depository.

FIG. 1 illustrates tenant identifier attribute definition in a subscriber database according to certain embodiments. As shown in FIG. 1, data can be sorted by IMSI ID, and each Tenant ID can be associated with a plurality of IMSI ID's. It is not necessary that each Tenant ID be associated with a plurality of IMSI IDs, but it is possible. Each IMSI ID can also be associated with a different Rating Group ID's.

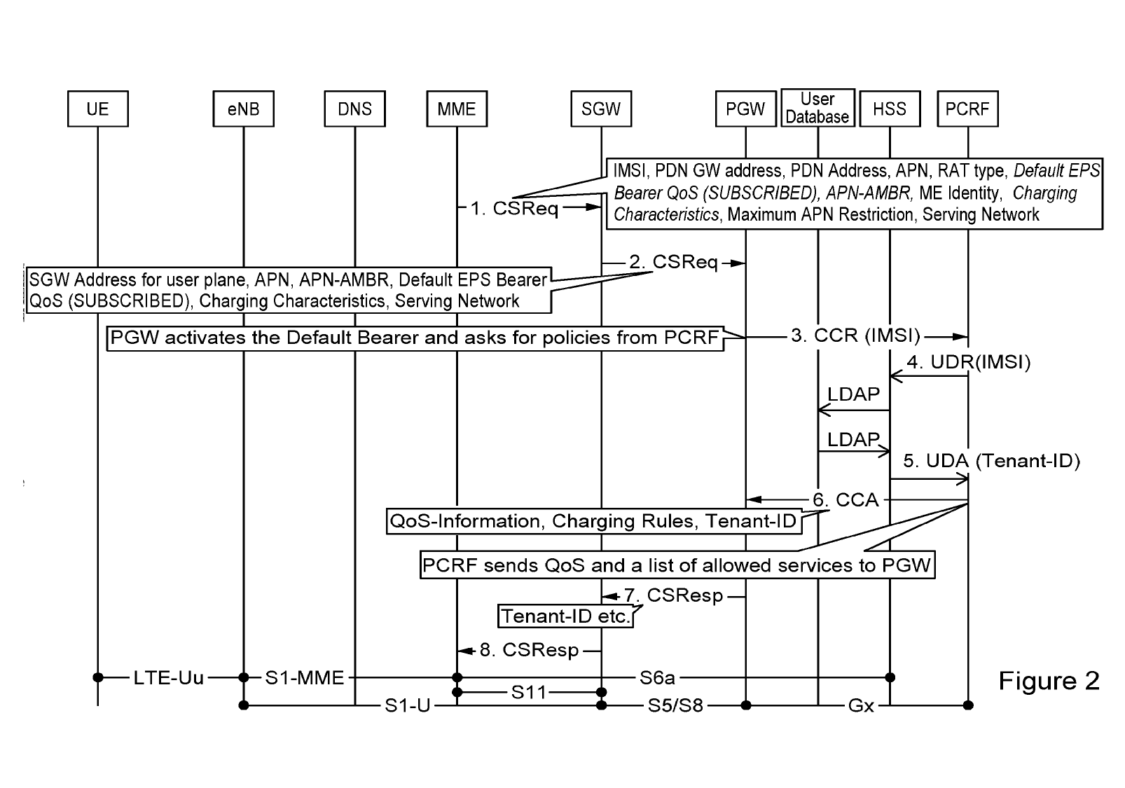

FIG. 2 illustrates an example call flow illustrating use cases according to certain embodiments. During the session establishment procedure, as a part of default or dedicated bearer creation, as indicated in FIG. 2, the HSS can pass the Tenant ID information about the subscriber to the policy decision engines, which in turn can pass the information to policy enforcing entities like PCEF, BBERF, or the like.

As shown in FIG. 2, a PCEF, in this case including a PGW, can send a credit control request (CCR-I) message with IMSI information to the PCRF. The PCRF can query the HSS/user database, using the UDR or other relevant message to get policy information applicable to an IMSI. In this case the HSS and user database are illustrated as separate entities that communicate with one another using lightweight directory access protocol (LDAP), although they may be combined as a single entity.

The HSS/User Databases can return the policies applicable to the IMSI along with the new multi-tenant attribute “Tenant ID”. The Tenant-ID can be passed along from the PCRF to the PCEF as a part of credit control accept (CCA-I) message. The MME can get the Tenant-ID information from the HSS/User Databases over, for example, the S6a interface during initial attach process. The MME can pass the Tenant-ID along to evolved Node B (eNB) in an initial context message. This process, however, is not shown in FIG. 2. “Tenant-ID” information can thus be available across all network elements whose resources are shared across tenants in hosting environments.

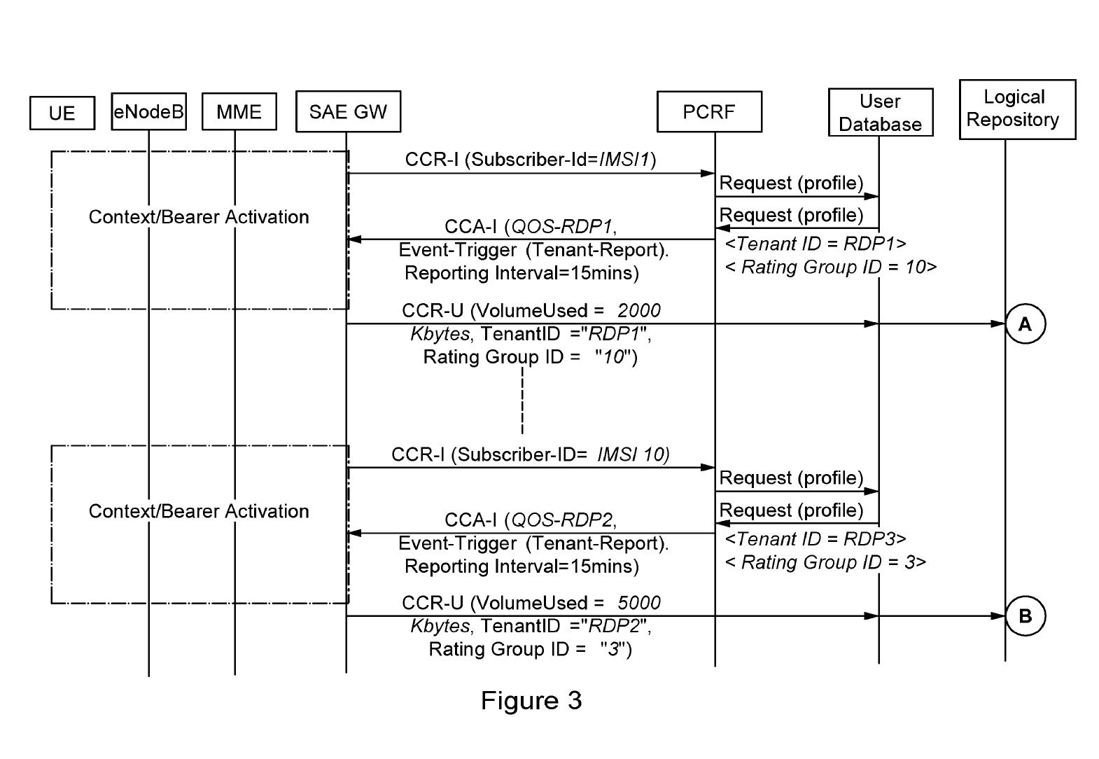

FIG. 3 illustrates an interaction of a logical depository with policy decision engines and policy enforcement engines according to certain embodiments. The call flow sequence shown in FIG. 3 is a use case depicting how certain embodiments could be applied

During the initial bearer creation process the policy enforcement or policy reporting function (PCEF or BBERF), in this case a system architecture evolution (SAE) gateway (GW) which contains the PCEF, can send a CCR-I message, with Subscriber ID set to IMSI of the user, to the PCRF. The PCRF can use the subscriber ID to query the User Database and fetch subscriber specific policies.

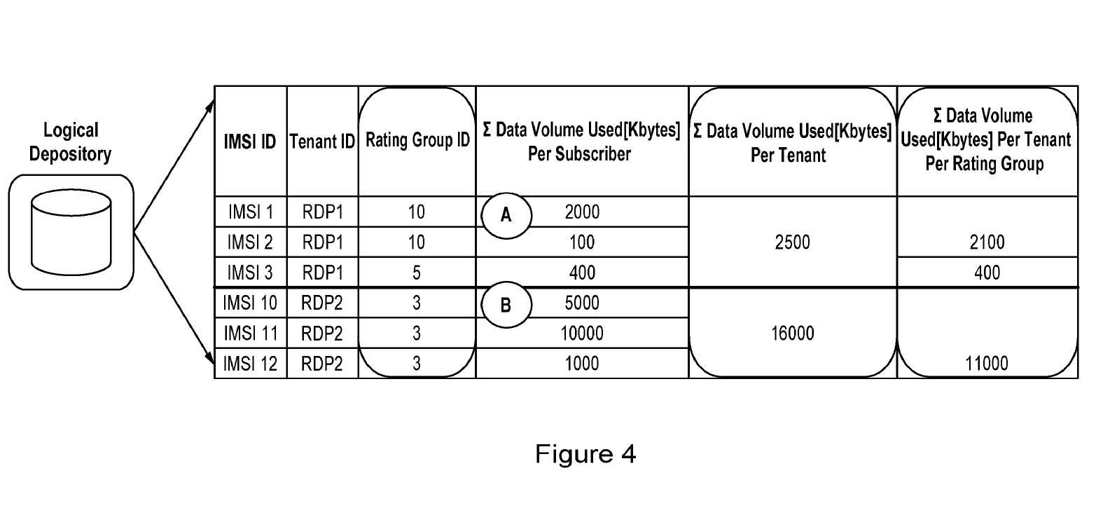

The user database can return information specific to the subscriber. The information can include, for example, Tenant ID, quality of service (QOS) Policy, Rating Group ID, and so forth. FIG. 3 illustrates two examples. In example A, for IMSI 1, the User Database can return <Tenant ID=RDP1> and <Rating Group ID=10>, which can be the data associated with IMSI 1 as defined in FIG. 4. In example B, for IMSI 10, the User Database returns <Tenant ID=RDP3> and <Rating Group ID=3>, which can be data associated with IMSI 10 defined in FIG. 4.

PCRF can now decide on applicable policies for the subscriber and can send CCA-I to the PCEF. Additionally, various event based reporting triggers can be configured by the PCRF on the PCEF. Note that the PCRF or other network elements may have also pre-configured policies per Tenant ID which can be reported to the PCRF. Based on the triggering conditions configured, the PCEF can report measurements back to PCRF when a particular event gets triggered. An event trigger, called tenant report, can carry additional attributes like ‘Reporting Interval’, ‘Reporting Threshold,’ and the like.

In example A, for IMSI 1, in the CCA-I message the PCRF can respond with <QOS Policy ID=QOS-RDP1>, <Tenant ID =RDP1>, <Event Trigger=Tenant Report> and <Reporting Interval=15 minutes>. Similarly, in example B, for IMSI 10, in the CCA-I message the PCRF can respond with <QOS Policy ID=QOS-RDP2>, <Tenant ID=RDP3>, <Event Trigger=Tenant Report> and <Reporting Interval=15 minutes>

The PCEF can enforce the policies laid down by PCRF. As per the event trigger configured, the PCEF can report volume measurements. In example A, for IMSI 1 after 15 minutes, the PCEF can send a CCR-U message with data volume updates, for example <Volume Used=2000 Kbytes>, <Tenant ID=RDP1> and <Reporting Group ID=10>. For IMSI 10 after 15 minutes, the PCEF can send a CCR-U message with data volume updates, for example <Volume Used=5000 Kbytes>, <Tenant ID=RDP2> and <Reporting Group ID=3>.

The PCEF can send the tenant reports directly to a logical depository or it could send it to PCRF which in turn relays the information back to the logical depository.

The logical depository can compile all the data received from the PCEF, aggregate data into logical metrics (as defined by host and tenants) and store them in database instances.

FIG. 4 illustrates how a logical depository can compile, aggregate and store data according to certain embodiments. As shown in FIG. 4, logical depository data can be customized by operators. Operators can define various performance metrics based on data volume, throughput, and the like and can also define unique aggregation methods for example by tenant, rating groups, and the like.

As shown in FIG. 4, data can be sorted by IMSI ID, and each Tenant ID can be associated with a plurality of IMSI ID. It is not necessary that each Tenant ID be associated with a plurality of IMSI IDs, but it is possible. Each IMSI ID can also be associated with one or more Rating Group ID's and a total data volume used per subscriber, which may be measured in units such as kilobytes (Kbytes). Each group of IMSI IDs associated with a Tenant ID can further be associated with a total data volume used per tenant. Moreover, each group of IMSI IDs associated with a rating group can be associated with a total data volume used per rating group.

This may contrast with an approach in which a network operator uses PLMN ID and IMSIs to report and account for charging roaming cost and hosted subscriber cost.

In certain embodiments, a tenant identifier is uniquely associated with each subscriber, each device, or each device component. The tenant identifier can provide an ability to monitor the usage of an individual tenant's subscribers, support a unique identity for billing and charging data record (CDR) generation and also implement policy decisions using PCRF to control overall network usage by individual tenants hosted by network operator. The unique tenant identifier can further be used in connections with control methods for scheduling the users in the radio network by, for example, an eNB.

When it comes to QoS, subscribers may be categorized into different categories(e.g. Platinum, Gold, Silver, and Bronze)s. In a hosted environment, a Gold subscriber of one tenant and Silver subscriber of another tenant may have same quality class indicator (QCI) and/or allocation and retention priority (ARP) values for a certain service. The hosted operators may also have their own HSS. Now, for the network operator it may become valuable either to overwrite the QCI and/or ARP values or to have individual dedicated QCI per hosted partner to schedule the users accordingly to scheduling methods. Having an individual tenant ID AVP along with QCI and/or ARP values may provide an ability to efficiently address conflicting scenarios where several hosted subscribers provisioned QCI for different services may conflict network operator's QCI and/or ARP policy.

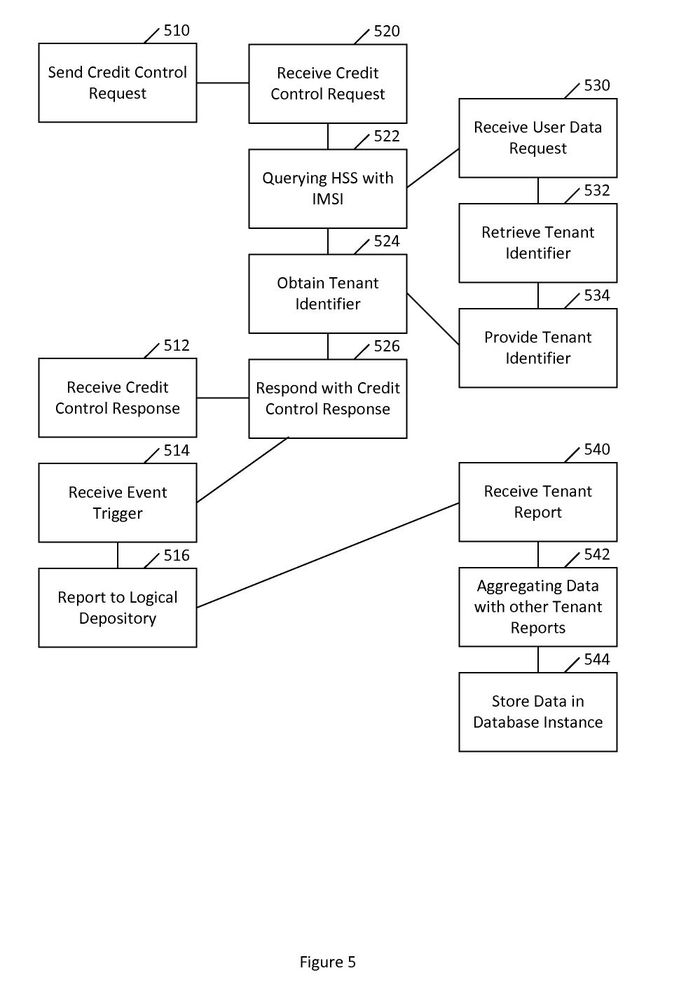

FIG. 5 illustrates a method according to certain embodiments. As shown in FIG. 5, a method can include, at 510, sending a credit control request to a policy control function. The request can include an international mobile subscriber identity. The method can also include, at 512, receiving a credit control response from the policy control function. The response can include a tenant identifier corresponding to the international mobile subscriber identity.

The method can further include, at 514, receiving, associated with the tenant identifier, an event trigger and reporting interval from the policy control function. The method can additionally include, at 516, reporting, in a report, usage associated with the tenant identifier and event to a logical depository. The report can include the tenant identifier. The report can include a rating group identifier. The reporting can be done directly to a logical depository or the reporting can be done indirectly, such as to the logical depository via the policy control function.

The method can also include, at 520, receiving the credit control request at the policy control function. The method can also include, at 522, querying, by the policy control function, a home subscriber server with a query, wherein the query comprises the international mobile subscriber identity. The method can further include, at 524, obtaining a tenant identifier corresponding to the international mobile subscriber identity from the home subscriber server in response to the query. The method can additionally include, at 526, responding with the response to the credit control request based on the tenant identifier. The response can include the tenant identifier.

The method can further include, at 530, receiving a user data request from a policy control function. The request can include an international mobile subscriber identity. The method can additionally include, at 532, retrieving a tenant identifier associated with the international mobile subscriber identity in response to the request. The method can also include, at 534, providing the tenant identifier in a user data acknowledgment to the policy control function. The retrieving can include querying a user database using a lightweight directory access protocol.

The method can also include, at 540, receiving a tenant report from a policy enforcement function or a policy control function. The method can further include, at 542, aggregating data in the tenant report with data from other tenant reports. The method can additionally include, at 544, storing the data in a database instance. The aggregating can include grouping the data according to at least one of a tenant identifier or a rating group. For example, the data can be grouped first according to tenant identifier and then according to rating group, as illustrated in FIG. 4 above.

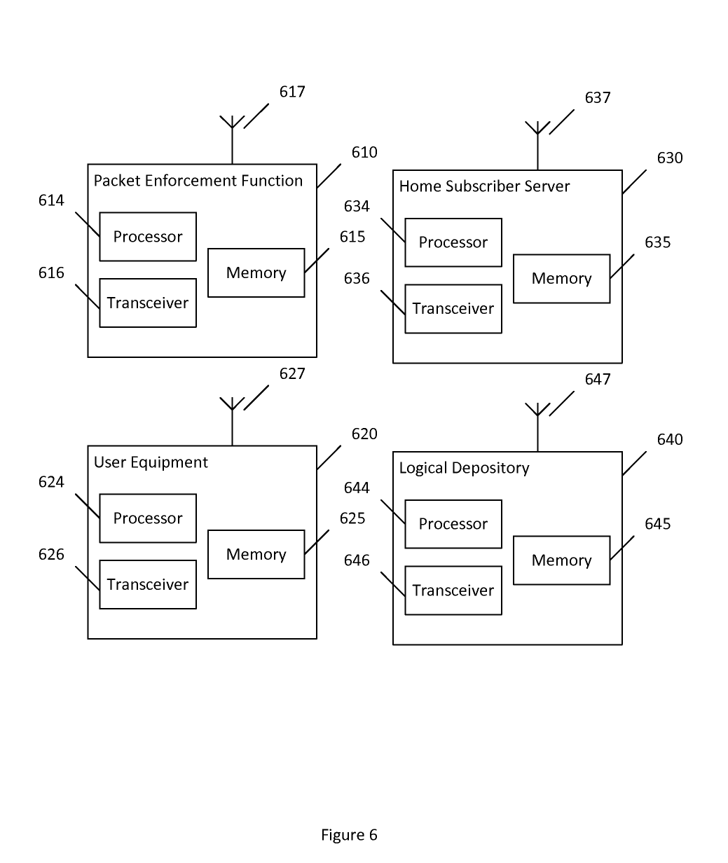

FIG. 6 illustrates a system according to certain embodiments of the invention. In one embodiment, a system may comprise several devices, such as, for example, packet enforcement function 610, packet control function 620, home subscriber server 630, and logical depository 640. The system may comprise more than one packet control function 620 and more than one packet enforcement function 610, although only one of each is shown for the purposes of illustration. A packet enforcement function can be a P-GW, SAE GW or any other suitable device. Each of these devices may comprise at least one processor, respectively indicated as 614, 624, 634, and 644. At least one memory may be provided in each device, and indicated as 615, 625, 635, and 645, respectively. The memory may comprise computer program instructions or computer code contained therein. One or more transceiver 616, 626, 636, and 646 may be provided, and each device may also comprise an antenna, respectively illustrated as 617, 627, 637, and 647. Although only one antenna each is shown, many antennas and multiple antenna elements may be provided to each of the devices. Other configurations of these devices, for example, may be provided. For example, packet enforcement function 610, packet control function 620, home subscriber server 630, and logical depository 640 may be additionally or solely configured for wired communication. In such a case antennas 617, 627, 637, and 647 may illustrate any form of communication hardware, without being limited to merely an antenna. For example, antennas 617, 627, 637, and 647 may illustrate any form of wired communication hardware, such as a network interface card.

Transceivers 616, 626, 636, and 646 may each, independently, be a transmitter, a receiver, or both a transmitter and a receiver, or a unit or device that may be configured both for transmission and reception.

Processors 614, 624, 634, and 644 may be embodied by any computational or data processing device, such as a central processing unit (CPU), application specific integrated circuit (ASIC), or comparable device. The processors may be implemented as a single controller, or a plurality of controllers or processors.

Memories 615, 625, 635, and 645 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language.

The memory and the computer program instructions may be configured, with the processor for the particular device, to cause a hardware apparatus such as packet enforcement function 610, packet control function 620, home subscriber server 630, and logical depository 640, to perform any of the processes described above (see, for example, FIGS. 2, 3, and 5). Therefore, in certain embodiments, a non-transitory computer-readable medium may be encoded with computer instructions that, when executed in hardware, may perform a process such as one of the processes described herein. Alternatively, certain embodiments of the invention may be performed entirely in hardware.

Furthermore, although FIG. 6 illustrates a system including policy enforcement function/Bearer Binding Event Reporting 610, packet control function 620, home subscriber server 630, and logical depository 640, embodiments of the invention may be applicable to other configurations, and configurations involving additional elements, as illustrated and discussed herein (see, for example, FIGS. 2 and 3).

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY

3G Third Generation
3GPP Third Generation Partnership Project for UMTS
3GPP2 Third Generation Partnership Project for CDMA 2000
AVP Attribute Value Pair
BBERF Bearer Binding Event Reporting Function
CCA Credit Control Accept
CCR Credit Control Request
CDMA Code Division Multiple Access
CDR Charge Data Record
DNS Domain Name Server
eNB Enhanced Node B
EGPRS Enhanced General Packet Radio Services
EPS Evolved Packet System
GGSN Gateway GPRS Support Node
GSM Global System for Mobile Communications
HSDPA High Speed Downlink Packet Access
HSGW High Speed Packet Data Serving Gateway
HSS Home Subscriber Server
IMS IP Multimedia Sub System
IMSI International Mobile Subscriber Identity
LDAP Lightweight Directory Access Protocol
MME Mobility Management Entity
MOWN Multi Operator Wholesale Network
PCEF Policy Control Enforcement Function
PCRF Policy Charging And Rules Function
PGW Packet Data Network Gateway
PLMN Public Land Mobile Network
RDP Retail Distribution Partner
SGW Serving Gateway
UDR User Data Request
UDA User Data Acknowledge
UE User Equipment
UL Uplink
UMTS Universal Mobile Telecommunication System
WCDMA Wideband Code Division Multiple Access

1. A method, comprising:
receiving a credit control request at a policy control function, wherein the request comprises an international mobile subscriber identity;
querying, by the policy control function, a home subscriber server with a query, wherein the query comprises the international mobile subscriber identity;
obtaining a tenant identifier corresponding to the international mobile subscriber identity from the home subscriber server in response to the query; and
responding with a response to the credit control request based on the tenant identifier.

2. (canceled)

3. A method, comprising:
sending a credit control request to a policy control function, wherein the request comprises an international mobile subscriber identity; and
receiving a credit control response from the policy control function, wherein the response comprises a tenant identifier corresponding to the international mobile subscriber identity.

4. The method of claim 3, further comprising:
receiving, associated with the tenant identifier, an event trigger and reporting interval from the policy control function; and
reporting, in a report, usage associated with the tenant identifier and event to a logical depository, wherein the report comprises the tenant identifier.

5. The method of claim 4, wherein the report comprises a rating group identifier.

6. The method of claim 4, wherein the reporting comprises reporting directly to the logical depository or reporting to the logical depository via the policy control function.

7. A method, comprising:
receiving a user data request from a policy control function, wherein the request comprises an international mobile subscriber identity;
retrieving a tenant identifier associated with the international mobile subscriber identity in response to the request; and
providing the tenant identifier in a user data acknowledgment to the policy control function.

8. The method of claim 7, wherein the retrieving comprises querying a user database using a lightweight directory access protocol.

9. A method, comprising:
receiving a tenant report from a policy enforcement function or a policy control function;
aggregating data in the tenant report with data from other tenant reports; and
storing the data in a database instance.

10. The method of claim 9, wherein the aggregating comprises grouping the data according to at least one of a tenant identifier or a rating group.

11. An apparatus, comprising:
at least one processor; and
at least one memory including computer program code,
wherein the at least one memory and the computer program code are configured to, with the at least one processor, cause the apparatus at least to
receive a credit control request at a policy control function, wherein the request comprises an international mobile subscriber identity;
query, by the policy control function, a home subscriber server with a query, wherein the query comprises the international mobile subscriber identity;
obtain a tenant identifier corresponding to the international mobile subscriber identity from the home subscriber server in response to the query; and
respond with a response to the credit control request based on the tenant identifier.

12. The apparatus of claim 11, wherein the response comprises the tenant identifier.

13. An apparatus, comprising:
at least one processor; and
at least one memory including computer program code,
wherein the at least one memory and the computer program code are configured to, with the at least one processor, cause the apparatus at least to
send a credit control request to a policy control function, wherein the request comprises an international mobile subscriber identity; and
receive a credit control response from the policy control function, wherein the response comprises a tenant identifier corresponding to the international mobile subscriber identity.

14. The apparatus of claim 13, wherein the at least one memory and the computer program code are configured to, with the at least one processor, cause the apparatus at least to
receive, associated with the tenant identifier, an event trigger and reporting interval from the policy control function; and
report, in a report, usage associated with the tenant identifier and event to a logical depository, wherein the report comprises the tenant identifier.

15. The apparatus of claim 14, wherein the report comprises a rating group identifier.

16. The apparatus of claim 14, wherein the at least one memory and the computer program code are configured to, with the at least one processor, cause the apparatus at least to report directly to the logical depository or report to the logical depository via the policy control function.

17. An apparatus, comprising:
at least one processor; and
at least one memory including computer program code,
wherein the at least one memory and the computer program code are configured to, with the at least one processor, cause the apparatus at least to
receive a user data request from a policy control function, wherein the request comprises an international mobile subscriber identity;
retrieve a tenant identifier associated with the international mobile subscriber identity in response to the request; and
provide the tenant identifier in a user data acknowledgment to the policy control function.

18. The apparatus of claim 17, wherein the at least one memory and the computer program code are configured to, with the at least one processor, cause the apparatus at least to retrieve by querying a user database using a lightweight directory access protocol.

19. An apparatus, comprising:
at least one processor; and
at least one memory including computer program code,
wherein the at least one memory and the computer program code are configured to, with the at least one processor, cause the apparatus at least to
receive a tenant report from a policy enforcement function or a policy control function;
aggregate data in the tenant report with data from other tenant reports; and
store the data in a database instance.

20. The apparatus of claim 19, wherein the at least one memory and the computer program code are configured to, with the at least one processor, cause the apparatus at least to aggregate by grouping the data according to at least one of a tenant identifier or a rating group.

21.-32. (canceled)
